(19) United States
(12) Patent Application Publication
(10) Pub. No.: US 2026/0004731 A1
(43) Pub. Date: Jan. 1, 2026

(54) EMISSION DRIVING CIRCUIT, DISPLAY DEVICE INCLUDING THE EMISSION DRIVING CIRCUIT AND ELECTRONIC DEVICE INCLUDING THE DISPLAY DEVICE

(71) Applicant: Samsung Display Co., Ltd., Yongin-si (KR)

(72) Inventors: MINWOO BYUN, Yongin-si (KR); MINJOO KIM, Yongin-si (KR)

(21) Appl. No.: 19/200,454

(22) Filed: May 6, 2025

(30) Foreign Application Priority Data
Jul. 1, 2024 (KR) 10-2024-0086052

(51) Int. Cl. G09G 3/3233; G09G 3/32

(52) U.S. Cl. CPC G09G 3/3233; G09G 3/32; G09G 2300/0819; G09G 2300/0842; G09G 2300/0861; G09G 2310/08; G09G 2320/0247

(57) ABSTRACT

An emission driving circuit includes: a pull-up controller configured to transmit a first voltage to a first pull-up control node in response to an input signal, to control a voltage of a second pull-up control node in response to a voltage of the first pull-up control node and a clock signal, and to transmit a second voltage to a third pull-up node in response to the voltage of the second pull-up control node; a pull-down controller configured to transmit the input signal to a second pull-down node in response to the input signal and the clock signal; and an output circuit configured to output an emission signal from an output node in response to a voltage of the third pull-up control node and a voltage of the second pull-down control node.

### CROSS-REFERENCE TO RELATED APPLICATION

The present application claims priority to and the benefit of Korean Patent Application No. 10-2024-0086052, filed on Jul. 1, 2024, in the Korean Intellectual Property Office, the entire disclosure of which is incorporated herein by reference.

### BACKGROUND

### 1. Field

Aspects of some embodiments of the present disclosure relate to an emission driving circuit, a display device, and an electronic device.

### 2. Description of the Related Art

Generally, a display device includes a display panel and a display panel driving circuit. The display panel includes a plurality of scan lines, a plurality of data lines, a plurality of emission lines, and a plurality of pixel circuits. The display panel driver includes a scan driver providing scan signals to the plurality of scan lines, a data driver providing data voltages to the plurality of data lines, an emission driver providing emission signals to the plurality of emission lines, and a driving controller controlling the scan driver, the data driver and the emission driver.

The emission driver may include a plurality of emission driving circuits. When a clock signal is applied to a gate electrode of a pull-up transistor of the emission driving circuit, a level of the clock signal may be changed by a load. The level of the clock signal is changed, so that the pull-up transistor may not be turned on when the pull-up transistor should be turned on. A turn on level of the pull-up transistor may be unstable. Accordingly, a stability of the emission driving circuit may decrease, and a flicker may occur.

The above information disclosed in this Background section is only for enhancement of understanding of the background and therefore the information discussed in this Background section does not necessarily constitute prior art.

### SUMMARY

Aspects of some embodiments of the present disclosure relate to an emission driving circuit, a display device, and an electronic device. For example, aspects of some embodiments of the present disclosure relate to the emission driving circuit, the display device including the emission driving circuit, and the electronic device including the display device.

Aspects of some embodiments of the present disclosure include an emission driving circuit with relatively improved a stability.

Aspects of some embodiments of the present disclosure include a display device including the emission driving circuit.

Aspects of some embodiments of the present disclosure include an electronic device including the display device.

According to some embodiments of the present disclosure, in an emission driving circuit, the emission driving circuit includes a pull-up controller configured to transmit a first voltage to a first pull-up control node in response to an input signal, control a voltage of a second pull-up control node in response to a voltage of the first pull-up control node and a clock signal, and transmit a second voltage to a third pull-up node in response to the voltage of the second pull-up control node, a pull-down controller configured to transmit the input signal to a second pull-down node in response to the input signal and the clock signal, and an output circuit configured to output an emission signal from an output node in response to a voltage of the third pull-up control node and a voltage of the second pull-down control node.

According to some embodiments, the pull-up controller may include a first transistor including a first gate electrode configured to receive the input signal, a first electrode configured to receive the first voltage, and a second electrode connected to the first pull-up control node, a second transistor including a first gate electrode connected to the first pull-up control node, a first electrode connected to the second pull-up control node, and a second electrode configured to receive the clock signal, a third transistor including a first gate electrode connected to the second pull-up control node, a first electrode connected to the third pull-up control node, and a second electrode configured to receive the second voltage, and a first capacitor including a first electrode connected to the first pull-up control node, and a second electrode configured to receive the clock signal.

According to some embodiments, the pull-up controller may further include a fourth transistor including a first gate electrode connected to a first pull-down control node, a first electrode configured to receive the first voltage, and a second electrode connected to the second pull-up control node. According to some embodiments, the fourth transistor may be configured to transmit the first voltage to the second pull-up control node in response to a voltage of the first pull-down control node.

According to some embodiments, the pull-up controller may further include a fifth transistor including a first gate electrode connected to the first pull-down control node, a first electrode configured to receive the first voltage, and a second electrode connected to the third pull-up control node, and a second capacitor including a first electrode configured to receive the first voltage, and a second electrode connected to the third pull-up control node.

According to some embodiments, the pull-down controller may further include a sixth transistor including a first gate electrode configured to receive the clock signal, a first electrode configured to receive the input signal, and a second electrode connected to a first pull-down control node, and a seventh transistor including a first gate electrode configured to receive the second voltage, a first electrode connected to the first pull-down control node, and a second electrode connected to the second pull-down control node.

According to some embodiments, the output circuit may include an eighth transistor including a first gate electrode connected to the third pull-up control node, a first electrode configured to receive the first voltage, and a second electrode connected to the output node, a ninth transistor including a first gate electrode connected to the second pull-down control node, a first electrode connected to the output node, and a second electrode configured to receive the second voltage, and a third capacitor including a first electrode connected to the second pull-down control node, and a second electrode connected to the output node.

According to some embodiments, at least one transistor of a plurality of transistors included in the emission driving circuit may include a first gate electrode and a second gate electrode.

According to some embodiments, the second gate electrode of the at least one transistor may be connected to the first gate electrode of the at least one transistor.

According to some embodiments of the present disclosure in a display device, the display device includes a display panel, a scan driver configured to output a scan signal to a scan line of the display panel, a data driver configured to output a data voltage to a data line of the display panel, and an emission driver including an emission driving circuit configured to output an emission signal to an emission line of the display panel. According to some embodiments, the emission driving circuit includes a pull-up controller configured to transmit a first voltage to a first pull-up control node in response to an input signal, control a voltage of a second pull-up control node in response to a voltage of the first pull-up control node and a clock signal, and transmit a second voltage to a third pull-up node in response to the voltage of the second pull-up control node, a pull-down controller configured to transmit the input signal to a second pull-down node in response to the input signal and the clock signal, and an output circuit configured to output the emission signal from an output node in response to a voltage of the third pull-up control node and a voltage of the second pull-down control node.

According to some embodiments, the pull-up controller may include a first transistor including a first gate electrode configured to receive the input signal, a first electrode configured to receive the first voltage, and a second electrode connected to the first pull-up control node, a second transistor including a first gate electrode connected to the first pull-up control node, a first electrode connected to the second pull-up control node, and a second electrode configured to receive the clock signal, a third transistor including a first gate electrode connected to the second pull-up control node, a first electrode connected to the third pull-up control node, and a second electrode configured to receive the second voltage and a first capacitor including a first electrode connected to the first pull-up control node, and a second electrode configured to receive the clock signal.

According to some embodiments, the pull-up controller may further include a fourth transistor including a first gate electrode connected to a first pull-down control node, a first electrode configured to receive the first voltage, and a second electrode connected to the second pull-up control node. According to some embodiments, the fourth transistor is configured to transmit the first voltage to the second pull-up control node in response to a voltage of the first pull-down control node.

According to some embodiments, the pull-up controller may further include a fifth transistor including a first gate electrode connected to the first pull-down control node, a first electrode configured to receive the first voltage, and a second electrode connected to the third pull-up control node, and a second capacitor including a first electrode configured to receive the first voltage, and a second electrode connected to the third pull-up control node.

According to some embodiments, the pull-down controller may further include a sixth transistor including a first gate electrode configured to receive the clock signal, a first electrode configured to receive the input signal, and a second electrode connected to a first pull-down control node, and a seventh transistor including a first gate electrode configured to receive the second voltage, a first electrode connected to the first pull-down control node, and a second electrode connected to the second pull-down control node.

According to some embodiments, the output circuit may include an eighth transistor including a first gate electrode connected to the third pull-up control node, a first electrode configured to receive the first voltage, and a second electrode connected to the output node, a ninth transistor including a first gate electrode connected to the second pull-down control node, a first electrode connected to the output node, and a second electrode configured to receive the second voltage, and a third capacitor including a first electrode connected to the second pull-down control node, and a second electrode connected to the output node.

According to some embodiments of the present disclosure, in an electronic device, the electronic device comprises a processor configured to output a control signal and input image data, a display panel, a scan driver configured to output a scan signal to a scan line of the display panel, a data driver configured to output a data voltage to a data line of the display panel, an emission driver including and emission driving circuit configured to output an emission signal to an emission line of the display panel, and a controller configured to control the scan driver, the data driver, and the emission driver based on the control signal and the input image data. According to some embodiments, the emission driving circuit includes a pull-up controller configured to transmit a first voltage to a first pull-up control node in response to an input signal, control a voltage of a second pull-up control node in response to a voltage of the first pull-up control node and a clock signal, and transmit a second voltage to a third pull-up node in response to the voltage of the second pull-up control node, a pull-down controller configured to transmit the input signal to a second pull-down node in response to the input signal and the clock signal, and an output circuit configured to output the emission signal from an output node in response to a voltage of the third pull-up control node and a voltage of the second pull-down control node.

According to some embodiments, the pull-up controller may include a first transistor including a first gate electrode configured to receive the input signal, a first electrode configured to receive the first voltage, and a second electrode connected to the first pull-up control node, a second transistor including a first gate electrode connected to the first pull-up control node, a first electrode connected to the second pull-up control node, and a second electrode configured to receive the clock signal, a third transistor including a first gate electrode connected to the second pull-up control node, a first electrode connected to the third pull-up control node, and a second electrode configured to receive the second voltage, and a first capacitor including a first electrode connected to the first pull-up control node, and a second electrode configured to receive the clock signal.

According to some embodiments, the pull-up controller may further include a fourth transistor including a first gate electrode connected to a first pull-down control node, a first electrode configured to receive the first voltage, and a second electrode connected to the second pull-up control node. According to some embodiments, the fourth transistor may be configured to transmit the first voltage to the second pull-up control node in response to a voltage of the first pull-down control node.

According to some embodiments, the pull-up controller may further include a fifth transistor including a first gate electrode connected to the first pull-down control node, a first electrode configured to receive the first voltage, and a second electrode connected to the third pull-up control node, and a second capacitor including a first electrode configured to receive the first voltage, and a second electrode connected to the third pull-up control node.

According to some embodiments, the pull-down controller may further include a sixth transistor including a first gate electrode configured to receive the clock signal, a first electrode configured to receive the input signal, and a second electrode connected to a first pull-down control node, and a seventh transistor including a first gate electrode configured to receive the second voltage, a first electrode connected to the first pull-down control node, and a second electrode connected to the second pull-down control node.

According to some embodiments, the output circuit may include an eighth transistor including a first gate electrode connected to the third pull-up control node, a first electrode configured to receive the first voltage, and a second electrode connected to the output node, a ninth transistor including a first gate electrode connected to the second pull-down control node, a first electrode connected to the output node, and a second electrode configured to receive the second voltage, and a third capacitor including a first electrode connected to the second pull-down control node, and a second electrode connected to the output node.

According to the emission driving circuit, the display device including the emission driving circuit, and the electronic device including the display device, a transistor is added to the emission driving circuit, so that a load for the clock signal may decrease. According to some embodiments, the second voltage is directly applied to the first gate electrode of a pull-up transistor included in the emission driving circuit, so that a turn on level of the pull-up transistor may stabilize. In addition, the second gate electrode connected to the first gate electrode of a transistor included in the emission driving circuit is added, so that a shift of a threshold voltage of the transistor due to a degradation may be prevented or reduced. Accordingly, an output signal of the emission driving circuit may stabilize.

### BRIEF DESCRIPTION OF THE DRAWINGS

The above and other features and characteristics of some embodiments of the present disclosure will become more apparent by describing in more detail aspects of some embodiments thereof with reference to the accompanying drawings, in which:

FIG. 1 is a block diagram illustrating a display device including an emission driver according to some embodiments of the present disclosure;

FIG. 2 is a block diagram illustrating the emission driver included in the display device of FIG. 1;

FIG. 3 is a circuit diagram illustrating an emission driving circuit included in the emission driver of FIG. 2;

FIG. 4 is a timing diagram illustrating an operation of the emission driving circuit of FIG. 3;

FIG. 5 is a circuit diagram illustrating an example of the operation of the emission driving circuit of FIG. 3 in a first period;

FIG. 6 is a circuit diagram illustrating an example of the operation of the emission driving circuit of FIG. 3 in a second period;

FIG. 7 is a circuit diagram illustrating an emission driving circuit included in the emission driver of FIG. 2;

FIG. 8 is an example of a pixel circuit included in the display device of FIG. 1;

FIG. 9 is a block diagram illustrating an electronic device according to some embodiments of the present disclosure; and

FIG. 10 is a diagram illustrating embodiments in which the electronic device of FIG. 9 is implemented as a smart phone.

### DETAILED DESCRIPTION

Hereinafter, display devices according to some embodiments will be described in more detail with reference to the accompanying drawings. The same reference numerals are used for the same components in the drawings, and some redundant descriptions of the same components may be omitted.

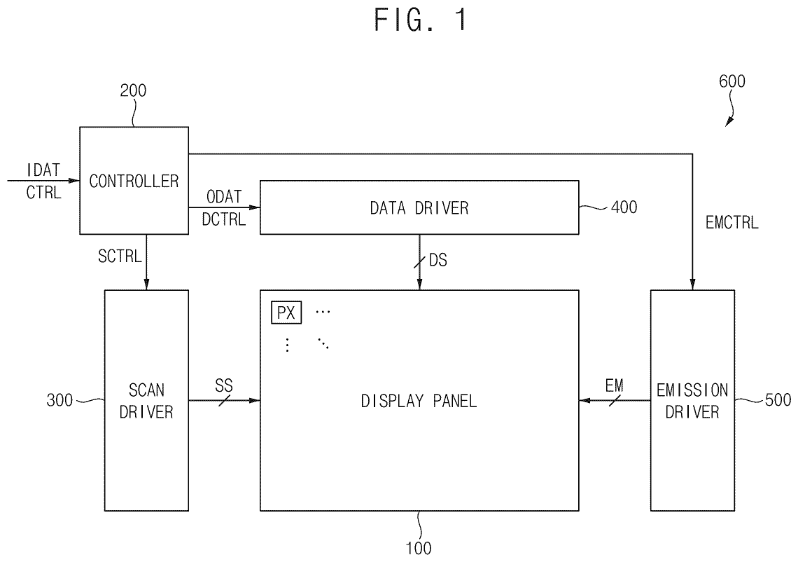

FIG. 1 is a block diagram illustrating a display device 600 including an emission driver 500 according to some embodiments of the present disclosure.

Referring to FIG. 1, the display device 600 may include a display panel 100 including a plurality of pixel circuits PX, a data driver 400 providing data signals DS to the plurality of pixel circuits PX, a scan driver 300 providing scan signals SS to the plurality of pixel circuits PX, the emission driver 500 providing emission signals EM to the plurality of pixel circuits PX, and a controller 200 controlling the data driver 400, the scan driver 300, and the emission driver 500.

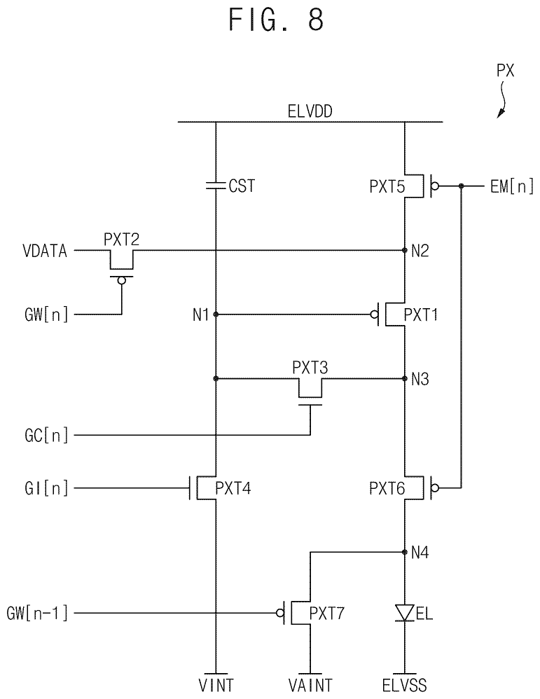

According to some embodiments, the scan signal SS applied to the pixel circuit PX may include a data writing gate signal GW[n], a previous data writing gate signal GW[n−1], a compensation gate signal GC[n], and an initialization gate signal GI[n] as illustrated in FIG. 8.

The display panel 100 may include data lines, scan lines, emission lines, and the plurality of pixel circuits PX. The pixel circuit PX may include a light emitting element. According to some embodiments, the light emitting element may be an organic light emitting diode (OLED). According to some embodiments, the light emitting element may be a nano light emitting diode (NED), a quantum dot light emitting diode (QLED), a micro light emitting diode, an inorganic light emitting diode, or any other suitable light emitting element. In addition, the pixel circuit PX may further include transistors to operate the light emitting element.

The data driver 400 may generate the data signals DS based on output image data ODAT received from the controller 200 and a data control signal DCTRL received from the controller 200, and provide the data signals DS to the plurality of pixel circuits PX through the data lines. According to some embodiments, the data control signal DCTRL may include an output data enable signal, a horizontal start signal, and a load signal, but the data control signal DCTRL is not limited thereto. According to some embodiments, the data driver 400 and the controller 200 may be implemented as a single integrated circuit, the single integrated circuit may be referred to as timing controller embedded data driver (TED). According to some embodiments, the data driver 400 and the controller 200 may each be implemented as separate integrated circuits.

The scan driver 300 may generate the scan signals SS based on a scan control signal SCTRL received from the controller 200, and provide the scan signal SS to the plurality of pixel circuits PX through the scan lines. According to some embodiments, the scan control signal SCTRL may include a scan start signal and a scan clock signal, but the scan control signal SCTRL is not limited thereto. According to some embodiments, the scan driver 300 may be integrated or formed into the display panel 100. According to some embodiments, the scan driver 300 may be implemented as one or more integrated circuits.

The emission driver 500 may generate the emission signals EM based on an emission control signal EMCTRL received from the controller 200, and provide the emission signals EM to the plurality of pixel circuits PX through the emission lines. According to some embodiments, the emission control signa EMCTRL may include a start signal, a clock signal, and an inverted clock signal, but the emission control signals EMCTRL is not limited thereto. According to some embodiments, the emission driver 500 may be integrated or formed into the display panel 100. According to some embodiments, the emission driver 500 may be implemented as one or more integrated circuits.

The controller 200 (e.g. the timing controller (T-CON)) may receive input image data IDAT and a control signal CTRL from an external device (e.g. an application processor (AP), a graphics processing unit (GPU), or a graphics card). According to some embodiments, the control signal CTRL may include a vertical synchronizing signal, a horizontal synchronizing signal, an input data enable signal, a master clock signal, and the like, but the control signal CTRL is not limited thereto. The controller 200 may generate the output image data ODAT, the data control signal DCTRL, the scan control signal SCTRL, and the emission control signal EMCTRL based on the input image data IDAT and the control signal CTRL. The controller 200 provides the output image data ODAT and the data control signal DCTRL to the data driver 400, so that the controller 200 may control the data driver 400. The controller 200 provides the scan control signal SCTRL to the scan driver 300, so that the controller 200 may control the scan driver 300. The controller 200 provides the emission control signal EMCTRL to the emission driver 500, so that the controller 200 may control the emission driver 500.

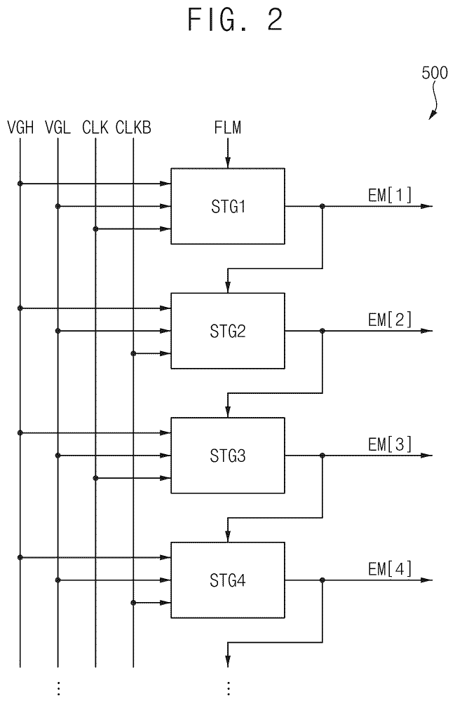

FIG. 2 is a block diagram illustrating the emission driver 500 included in the display device 600 of FIG. 1.

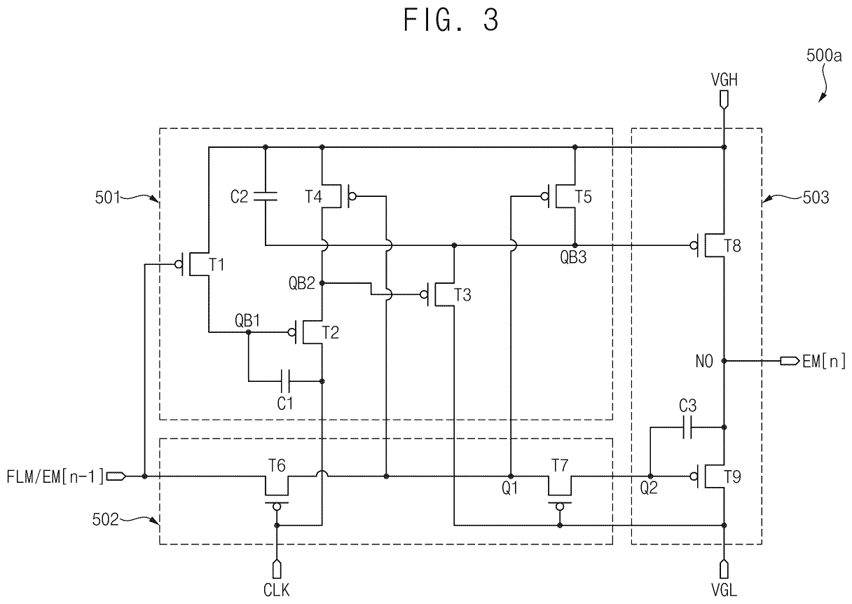

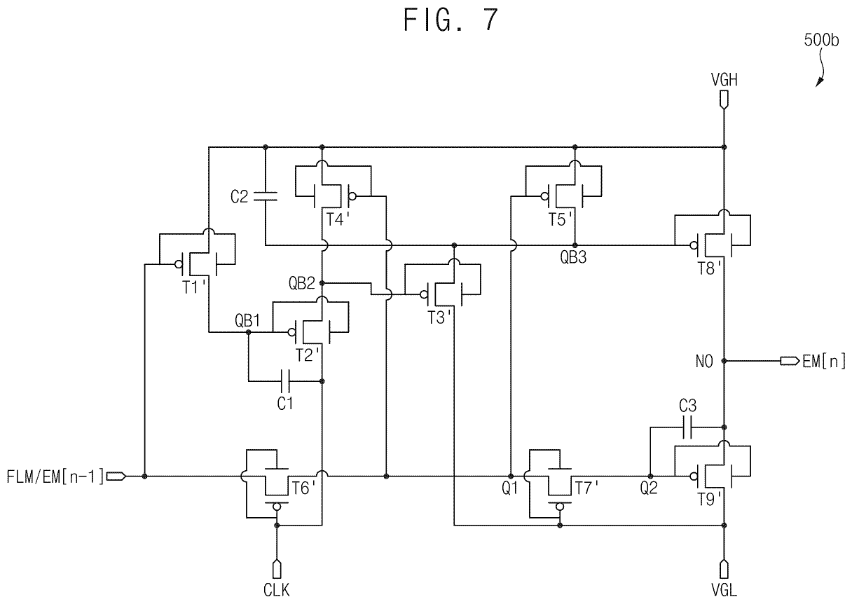

Referring to FIGS. 1 and 2, the emission driver 500 may include a plurality of stages STG1, STG2, STG3, STG4, . . . . The plurality of stages STG1, STG2, STG3, STG4, . . . may be referred to as a plurality of emission driving circuits. The plurality of stages STG1, STG2, STG3, STG4, . . . may receive the start signal FLM, the clock signal CLK, the inverted clock signal CLKB, a first voltage VGH (e.g. a high emission voltage), and a second voltage VGL (e.g. a low emission voltage), sequentially output the emission signals EM[1], EM[2], EM[3], EM[4], . . . to the plurality of pixel circuits PX in pixel rows. Each of the plurality of stages STG1, STG2, STG3, STG4, . . . may be an emission driving circuit 500a as illustrated in FIG. 3 or an emission driving circuit 500b as illustrated in FIG. 7.

An odd stages STG1, STG3, . . . may receive the clock signal CLK, and an even stages STG2, STG4, . . . may receive the inverted clock signal CLKB, but the odd stages STG1, STG3, . . . and the even stages STG2, STG4, . . . are not limited thereto. The odd stages STG1, STG3, . . . may be referred to as an odd emission driving circuits, and the even stages STG2, STG4, . . . may be referred to as an even emission driving circuits.

For example, a first stage STG1 may receive the clock signal CLK and the start signal FLM, and output a first emission signal EM[1]. A second stage STG2 may receive the inverted clock signal CLKB and the first emission signal EM[1], and output a second emission signal EM[2]. A third stage STG3 may receive the clock signal CLK and the second emission signal EM[2], and output a third emission signal EM[3]. A fourth stage STG4 may receive the inverted clock signal CLKB and the third emission signal EM[3], and output a fourth emission signal EM[5].

The first stage STG1 may be referred to as a first emission driving circuit, and the second stage STG2 may be referred to as a second emission driving circuit. The third stage STG3 may be referred to as a third emission driving circuit, and the fourth stage STG4 may be referred to as a fourth emission driving circuit.

FIG. 3 is a circuit diagram illustrating further details of the emission driving circuit 500a included in the emission driver 500 of FIG. 2. Although FIG. 3 illustrates various components in an emission driving circuit according to some embodiments, embodiments according to the present disclosure are not limited thereto, and according to various embodiments, the emission driving circuit may include additional components or fewer components without departing from the spirit and scope of embodiments according to the present disclosure.

Referring to FIG. 3, the emission driving circuit 500a may include a pull-up controller 501 controlling pull-up control nodes QB1, QB2, QB3, a pull-down controller 502 controlling pull-down nodes Q1, Q2, and an output circuit 503 outputting the emission signal EM[n] from the output node NO. The emission driving circuit 500a of FIG. 3 may be one of the plurality of stages STG1, STG2, STG3, STG4, . . . illustrated in FIG. 2.

The pull-up controller 501 may receive an input signals FLM/EM[n−1] and the clock signal CLK, control a first pull-up control node QB1, a second pull-up control node QB2, and a third pull-up control node QB3. According to some embodiments, when the emission driving circuit 500a is one of the odd stages STG1, STG3, . . . illustrated in FIG. 2, the pull-up controller 501 may receive the clock signal CLK, but when the emission driving circuit 500a is one of the even stages STG2, STG4, . . . illustrated in FIG. 2, the pull-up controller 501 may receive the inverted clock signal CLKB instead of the clock signal CLK.

The pull-up controller 501 may transmit the first voltage VGH to the first pull-up control node QB1 in response to the input signal FLM/EM[n−1], may control a voltage of the second pull-up control node QB2 in response to a voltage of the first pull-up control node QB1 and the clock signal CLK, may transmit the second voltage VGL to the third pull-up control node QB3 in response to the voltage of the second pull-up control node QB2. According to some embodiments, when the emission driving circuit 500a is the first stage STG1, the input signal FLM/EM[n−1] may be the start signal FLM, and when the emission driving circuit 500a is one of a subsequent stages STG2, STG3, STG4, . . . , the input signal FLM/EM[n−1] may be a previous emission signal EM[n−1]. The pull-down controller 502 may transmit the first voltage VGH to the pull-up control node QB2 in response to a voltage of the first pull-down control node Q1.

According to some embodiments, the pull-up controller 501 may include a first transistor T1, a second transistor T2, a third transistor, and a first capacitor C1.

The first transistor T1 may include a first gate electrode receiving the input signal FLM/EM[n−1], a first electrode receiving the first voltage VGH, and a second electrode connected to the first pull-up control node QB1.

The second transistor T2 may include a first gate electrode connected to the first pull-up control node QB1, a first electrode connected to the second pull-up control node QB2, and a second electrode receiving the clock signal CLK.

The third transistor T3 may include a first gate electrode connected to the second pull-up control node QB2, a first electrode connected to the third pull-up control node QB3, and a second electrode receiving the second voltage VGL.

The first capacitor C1 may include a first electrode connected to the first pull-up control node QB1, and a second electrode receiving the clock signal CLK.

In addition, the pull-up controller 501 may further include a fourth transistor T4 including a first gate electrode connected to the first pull-down control node Q1, a first electrode receiving the first voltage VGH, and a second electrode connected to the second pull-up control node QB2. The fourth transistor T4 may transmit the first voltage VGH to the second pull-up control node QB2 in response to the voltage of the first pull-down control node Q1.

The pull-up controller 501 may further include a fifth transistor T5 and a second capacitor C2.

The fifth transistor T5 may include a first gate electrode connected to the first pull-down control node Q1, a first electrode receiving the first voltage VGH, and a second electrode connected to the third pull-up control node QB3.

The second capacitor C2 may include a first electrode receiving the first voltage VGH, and a second electrode connected to the third pull-up control node QB3.

The pull-down controller 502 may transmit the input signal FLM/EM[n−1] to the second pull-down control node Q2 in response to the input signal FLM/EM[n−1] and the clock signal CLK.

According to some embodiments, the pull-down controller 502 may include a sixth transistor T6, and a seventh transistor T7.

The sixth transistor may include a first gate electrode receiving the clock signal CLK, a first electrode receiving the input signal FLM/EM[n−1], and a second electrode connected to the first pull-down control node Q1.

The seventh transistor may include a first gate electrode receiving the second voltage VGL, a first electrode connected to the first pull-down control node Q1, and a second electrode connected to the second pull-down control node Q2.

When the voltage of the second pull-down control node Q2 is bootstrapped, a channel current of the seventh transistor T7 may be zero. The seventh transistor T7 may be turned off while the voltage of the second pull-down control node Q2 is bootstrapped, and may block an electrical connection between the first pull-down control node Q1 and a first gate electrode of ninth transistor T9. In addition, the seventh transistor T7 may be turned on while the voltage of the second pull-down control node Q2 is not bootstrapped, and may electrically connect the first pull-down control node Q1 and the first gate electrode of the ninth transistor T9.

The output circuit 503 may output the emission signal EM[n] from the output node NO in response to the voltage of the pull-up control node QB3 and the voltage of the second pull-down control node Q2.

The output circuit 503 may include an eighth transistor T8, the ninth transistor T9, and a third capacitor C3.

The eighth transistor T8 may include a first gate electrode connected to the third pull-up control node QB3, a first electrode receiving the first voltage VGH, and a second electrode connected to the output node NO.

The ninth transistor T9 may include the first gate electrode connected to the second pull-down node Q2, a first electrode connected to the output node NO, and a second electrode receiving the second voltage VGL.

The third capacitor C3 may include a first electrode connected to the second pull-down control node Q2, and a second electrode connected to the output node NO.

The first through the ninth transistors T1 through T9 may be a same type. For example, the first through the ninth transistors T1 through T9 may be a PMOS transistor (P-channel metal oxide semiconductor transistor), but the first through the ninth transistors T1 through T9 are not limited thereto.

The first gate electrode of the third transistor T3 and the second electrode of the fourth transistor T4 are connected to the second pull-up control node QB2 and the first electrode of the third transistor T3 is connected to the third pull-up control node QB3, so that the clock signal CLK may be not directly applied to the second capacitor C2. The clock signal CLK is not directly applied to the second capacitor C2, so that a load for the clock signal CLK may decrease. The load for the clock signal CLK decreases, so that a rising time of the clock signal CLK and a falling time of the clock signal CLK may decrease, and a turn on level of the eighth transistor T8 may be stabilized. Accordingly, a stability and a reliability of the emission driving circuit 500a may increase.

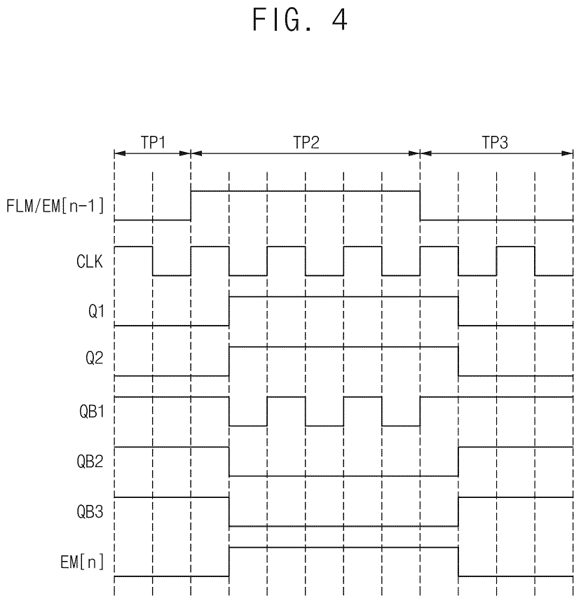

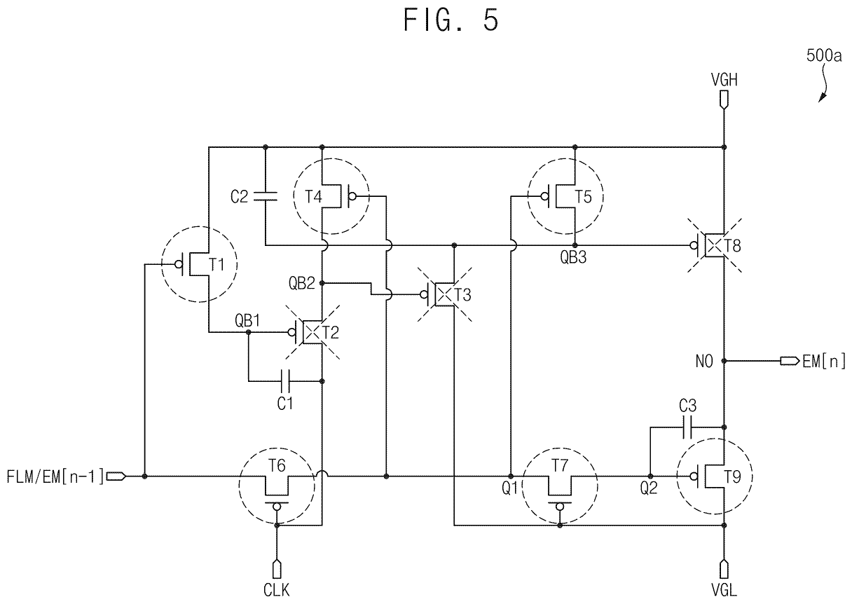

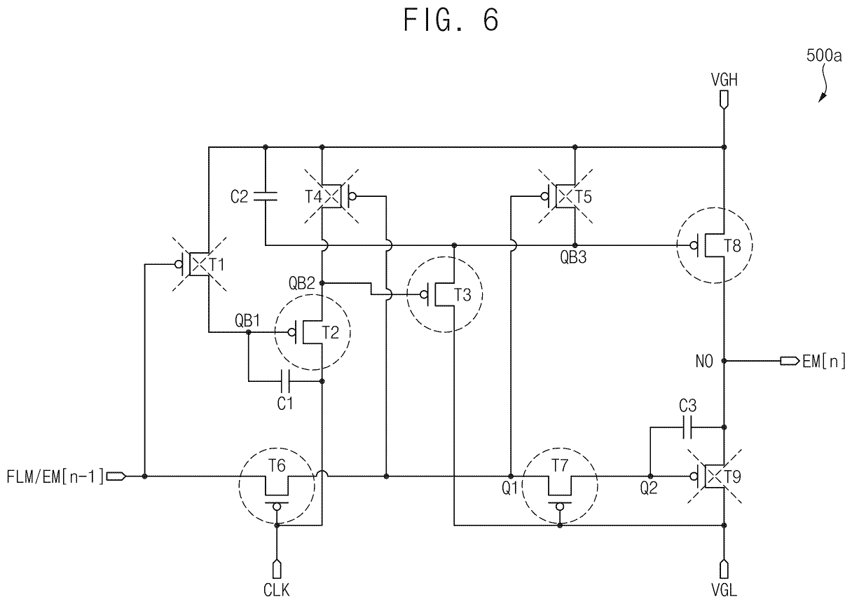

FIG. 4 is a timing diagram illustrating an operation of the emission driving circuit 500a of FIG. 3. FIG. 5 is a circuit diagram illustrating an example of the operation of the emission driving circuit 500a of FIG. 3 in a first period TP1. FIG. 6 is a circuit diagram illustrating an example of the operation of the emission driving circuit 500a of FIG. 3 in a second period TP2.

An activation level may be a low voltage (e.g. the second voltage VGL), and a deactivation level may be a high voltage (e.g. the first voltage VGH). The following explains the operation of the emission driving circuit 500a.

Referring to FIGS. 3 to 6, a signal periods in which the emission driving circuit 500a operates may include the first period TP1, the second period TP2, and a third period TP3.

In the first period TP1, a level of the input signal FLM/EM[n−1] may be the activation level, and the clock signal CLK may toggle between the deactivation level and the activation level.

In the first period TP1, as illustrated in FIG. 5, when the clock signal CLK has the activation level, the sixth transistor T6 may be turned on. The sixth transistor T6 may transmit the input signal FLM/EM[n−1] to the first pull-down control node Q1. The first pull-down control node Q1 may have the activation level. The seventh transistor T7 may always be turned on by the second voltage VGL. The seventh transistor T7 may transmit the voltage of the first pull-down control node Q1 to the second pull-down control node Q2. The second pull-down control node Q2 may have the activation level.

The first transistor T1 may be turned on in response to the input signal FLM/EM[n−1]. The first transistor T1 may transmit the first voltage VGH to the first pull-up control node QB1. The first pull-up control node QB1 may have the deactivation level. The second transistor T2 may be turned off in response to the voltage of the first pull-up control node QB1. The fourth transistor T4 may be turned on by the voltage of the first pull-down control node Q1. The fourth transistor T4 may transmit the first voltage VGH to the second pull-up control node QB2. The second pull-up control node QB2 may have the deactivation level. The third transistor T3 may be turned off by the voltage of the second pull-up control node QB2. The fifth transistor T5 may transmit the first voltage VGH to the third pull-up control node QB3. The third pull-up control node QB3 may have the deactivation level.

The ninth transistor T9 may be turned on by the voltage of the second pull-down control node Q2. The ninth transistor T9 may transmit the second voltage VGL to the output node NO. The output node NO may output the second voltage VGL as the emission signal EM[n].

The second capacitor C2 may stabilize the voltage of the third pull-up control node QB3.

The third capacitor C3 may store a difference between the voltage of the second pull-down control node Q2 and the voltage of the output node NO. In addition, the voltage of the second pull-down control node Q2 may be bootstrapped by the third capacitor C3.

In the second period TP2, the level of the input signal FLM/EM[n−1] may be the deactivation level, and the clock signal CLK may toggle between the deactivation level and the activation level.

In the second period TP2, as illustrated in FIG. 6, when the clock signal CLK has the activation level, the sixth transistor T6 may be turned on. The sixth transistor T6 may transmit the input signal FLM/EM[n−1] to the first pull-down control node Q1. The first pull-down control node Q1 may have the deactivation level. The seventh transistor T7 may always be turned on by the second voltage VGL. The seventh transistor T7 may transmit the voltage of the first pull-down control node Q1 to the second pull-down control node Q2. The second pull-down control node Q2 may have the deactivation level.

The first transistor T1 may be turned off in response to the input signal FLM/EM[n−1]. The first pull-up control node QB1 may be coupled to the clock signal CLK by the first capacitor C1. The first pull-up control node QB1 may have a same signal as the clock signal CLK. The second transistor T2 may be repeatedly turned on and off by the voltage of the first pull-up control node QB1. When the second transistor T2 is turned on, the second transistor T2 may transmit the clock signal CLK having the activation level to the second pull-up control node QB2. When second transistor T2 is turned off, the second pull-up control node QB2 may maintain the activation level. The third transistor T3 may be turned on by the voltage of the second pull-up control node QB2. The third transistor T3 may transmit the second voltage VGL to the third pull-up control node QB3. The third pull-up control node QB3 may have the activation level.

The fourth transistor T4 and the fifth transistor T5 may be turned off by the voltage of the first pull-down control node Q1 having the deactivation level.

The eighth transistor T8 may be turned on by the voltage of the third pull-up control node QB3. The eighth transistor may transmit the first voltage VGH to the output node NO. The output node NO may output the first voltage VGL as the emission signal EM[n].

The second capacitor C2 may stabilize the voltage of the third pull-up control node QB3. The third capacitor C3 may store the difference between the voltage of the second pull-down control node Q2 and the voltage of the output node NO.

The operation of the emission driving circuit 500a in third period TP3 is substantially the same as the operation of the emission driving circuit 500a in the first period TP1, a description of the operation of the emission driving circuit 500a in the third period TP3 is omitted.

In the second period TP2, the first gate electrode of the third transistor T3 and the second electrode of the fourth transistor T4 are connected to the second pull-up control node QB2 and the first electrode of the third transistor T3 is connected to the third pull-up control node QB3, so that the clock signal CLK may be not directly applied to the second capacitor C2. The clock signal CLK is not directly applied to the second capacitor C2, so that the load for the clock signal CLK may decrease. The load for the clock signal CLK decreases, so that the rising time of the clock signal CLK and the falling time of the clock signal CLK may decrease, and the turn on level of the eighth transistor T8 may be stabilized. Accordingly, the stability and the reliability of the emission driving circuit 500a may increase.

FIG. 7 is a circuit diagram illustrating an emission driving circuit 500b included in the emission driver 500 of FIG. 2. Although FIG. 7 illustrates various components in an emission driving circuit according to some embodiments, embodiments according to the present disclosure are not limited thereto, and according to various embodiments, the emission driving circuit may include additional components or fewer components without departing from the spirit and scope of embodiments according to the present disclosure.

Referring to FIG. 7, the emission driving circuit 500b may include a first transistor T1′, a second transistor T2′, a third transistor T3′, a fourth transistor T4′, a fifth transistor T5′, a sixth transistor T6′, a seventh transistor T7′, an eighth transistor T8′, a ninth transistor T9′, the first capacitor C1, the second capacitor C2, and the third capacitor C3. The emission driving circuit 500b of FIG. 7 is substantially the same as the emission driving circuit 500a of FIG. 3 expect that each of the first transistor T1′ to the ninth transistor T9′ further includes a second gate electrode. Thus, the same reference numerals will be used to refer to the same or like parts as those described in the previous embodiments of FIG. 3 and some repetitive explanation concerning the above elements may be omitted.

At least one of the first through the ninth transistors T1′ through T9′ included in the emission driving circuit 500b may further include the second gate electrode. For example, some of the first transistor T1′ to the ninth transistor T9′ may further include the second gate electrode. For example, the each of the first transistor T1′ to the ninth transistor T9′ may further include the second gate electrode.

The second gate electrode and the first gate electrode of a transistor further including the second gate electrode (hereinafter referred to as “a double gate transistor”) may be connected to each other.

When a voltage having the activation level is applied to the first gate electrode of the double gate transistor, the voltage having the activation level may be applied to the second gate electrode of the double gate transistor. When the voltage having the activation level is simultaneously applied to the first gate electrode and the second gate electrode, a wider path for holes (or electrons) to move in the active layer of the double gate transistor is formed, so that a mobility of a driving current of the double gate transistor and a magnitude of the driving current may increase. The magnitude of the driving current of the double gate transistor increase, so that the stability and the reliability of the emission driving circuit 500b may increase.

In addition, the first gate electrode of the double gate transistor is connected to the second gate electrode of the double gate transistor, so that a shift of a threshold voltage due to a degradation may be prevented or reduced, a leakage current may decrease, and the stability and the reliability of the emission driving circuit 500b may increase.

The first gate electrode of the third transistor T3′ and the second electrode of the fourth transistor T4′ are connected to the second pull-up control node QB2 and the first electrode of the third transistor T3′ is connected to the third pull-up control node QB3, so that the clock signal CLK may be not directly applied to the second capacitor C2. The clock signal CLK is not directly applied to the second capacitor C2, so that the load for the clock signal CLK may decrease. The load for the clock signal CLK decreases, so that the rising time of the clock signal CLK and the falling time of the clock signal CLK may decrease, and the turn on level of the eighth transistor T8′ may be stabilized. Accordingly, a stability and a reliability of the emission driving circuit 500b may increase.

FIG. 8 is an example of a pixel circuit PX included in the display device 600 of FIG. 1. Although FIG. 8 illustrates various components in a pixel circuit according to some embodiments, embodiments according to the present disclosure are not limited thereto, and according to various embodiments, the pixel circuit may include additional components or fewer components without departing from the spirit and scope of embodiments according to the present disclosure.

Referring to FIGS. 1 to 8, the pixel circuit PX may include a first pixel transistor PXT1 to a seventh pixel transistor PXT7, a storage capacitor CST, and a light emitting element EL.

The first pixel transistor PXT1 may include a control electrode connected to a first node N1, a first electrode connected to a second node N2, and a second electrode connected to a third node N3. The first pixel transistor PXT1 may generate a driving current based on a difference between a voltage of the first node N1 and a voltage of the second node N2.

The second pixel transistor PXT2 may include a control electrode receiving the data writing gate signal GW[n], a first electrode receiving a data voltage VDATA, and a second electrode connected to the second node N2. Herein, n is a positive integer greater than or equal to 1. The second pixel transistor PXT2 may provide the data voltage VDATA to the second node N2 in response to the data wiring gate signal GW[n].

The third pixel transistor PXT3 may include a control electrode receiving the compensation gate signal GC[n], a first electrode connected to the third node N3, and a second electrode connected to the first node N1. The third pixel transistor PXT3 may diode connect the first pixel transistor PXT1 in response to the compensation gate signal GC[n].

The fourth pixel transistor PXT4 may include a control electrode receiving the initialization gate signal GI[n], a first electrode receiving an initialization voltage VINT, and a second electrode connected to the first node N1. The fourth pixel transistor PXT4 may provide the initialization voltage VINT to the first node N1 in response to the initialization gate signal GI[n].

The fifth pixel transistor PXT5 may include a control electrode receiving the emission signal EM[n], a first electrode receiving a first pixel voltage ELVDD, and a second electrode connected to the second node N2.

The sixth pixel transistor PXT6 may include a control electrode receiving the emission signal EM[n], a first electrode connected to the third node N3, and a second electrode connected to a fourth node N4.

The fifth pixel transistor PXT5 and the sixth pixel transistor PXT6 may control a light emission of the light emitting element EL in response to the emission signal EM[n].

The seventh pixel transistor PXT7 may include a control electrode receiving the previous data writing gate signal GW[n−1], a first electrode receiving an anode initialization voltage VAINT, and a second electrode connected to the fourth node N4.

The seventh pixel transistor PXT7 may provide the anode initialization voltage VAINT to the fourth node N4 in response to the previous data writing gate signal GW[n−1] of the previous stage (or previous emission driving circuit).

The storage capacitor CST may include a first electrode receiving the first pixel voltage ELVDD, and a second electrode connected to the first node N1. The storage capacitor CST may store the data voltage VDATA.

The light emitting element EL may include am anode electrode connected to the fourth node N4, and a cathode electrode receiving a second pixel voltage ELVSS. The light emitting element EL may emit light based on the driving current. A magnitude of the driving current is determined based on the data voltage VDATA, so that a light emission intensity of the light emitting element EL may be determined based on the data voltage VDATA.

According to some embodiments, the first, the second, and the fifth to the seventh pixel transistors PXT1, PXT2, PXT5 to PXT7 may be a P-type transistor. For example, the p-type transistor may be the PMOS transistor (P-channel metal oxide semiconductor transistor), but the first, the second, and the fifth to the seventh pixel transistors PXT1, PXT2, PXT5 to PXT7 are not limited thereto. According to some embodiments, the first pixel transistor PXT1 to the seventh pixel transistor PXT7 may be the P-type transistor. According to some embodiments, the first pixel transistor PXT1 to the seventh pixel transistor PXT7 may be a N-type transistor.

In addition, the pixel circuit PX is described as including seven transistor and one capacitor in FIG. 8, but the pixel circuit PX is not limited thereto. For example, the pixel circuit PX may include at least two or more pixel transistors and/or two or more capacitors.

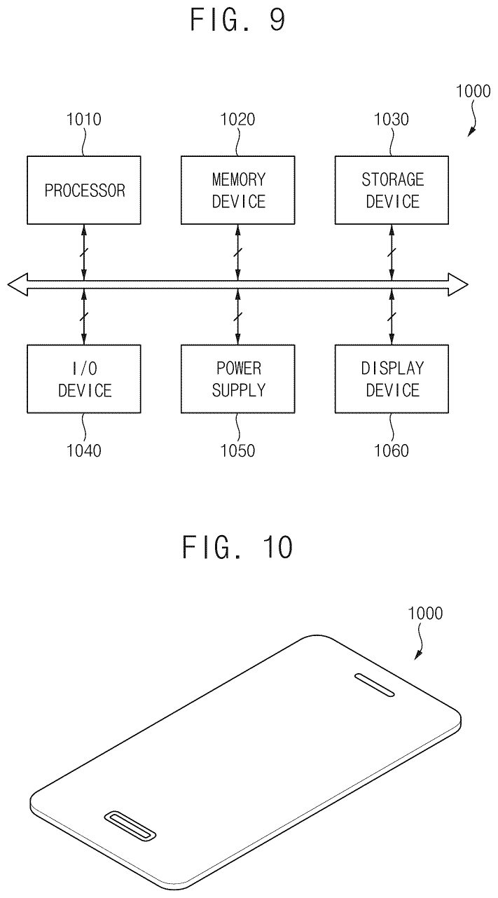

FIG. 9 is a block diagram illustrating an electronic device 1000 according to some embodiments of the present disclosure. FIG. 10 is a diagram illustrating embodiments in which the electronic device 1000 of FIG. 9 is implemented as a smart phone.

Referring to FIGS. 9 and 10, the electronic device 1000 may include a processor 1010, a memory device 1020, a storage device 1030, an input/output (I/O) device 1040, a power supply 1050, and a display device 1060. According to some embodiments, the display device 1060 may be the display device 600 of FIG. 1. In addition, the electronic device 1000 may further include ports for communicating with a video card, a sound card, a memory card, an universal serial bus (USB) device, an other electronic device, and the like.

According to some embodiments, as illustrated in FIG. 10, the electronic device 1000 may be implemented as the smart phone. However, the electronic device 1000 is not limited thereto. For example, the electronic device 1000 may be implemented as a cellular phone, a video phone, a smart pad, a smart watch, a tablet PC, a car navigation system, a computer monitor, a laptop, a head mounted display (HMD) device, and the like.

The processor 1010 may perform various computing functions. The processor 1010 may be a micro processor, a central processing unit (CPU), an application processor (AP), and the like. The processor 1010 may be coupled to other components via an address bus, a control bus, a data bus, and the like. Further, the processor 1010 may be coupled to an extended bus such as a peripheral component interconnection (PCI) bus.

The processor 1010 may output the input image data IDAT and the control signal CTRL to the controller 200 of FIG. 1.

The memory device 1020 may store data for operations of the electronic device 1000. For example, the memory device 1020 may include at least one non-volatile memory device such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, a ferroelectric random access memory (FRAM) device, and the like and/or at least one volatile memory device such as a dynamic random access memory (DRAM) device, a static random access memory (SRAM) device, a mobile DRAM device, and the like.

The storage device 1030 may include a solid state drive (SSD) device, a hard disk drive (HDD) device, a CD-ROM device, and the like.

The I/O device 1040 may include an input device such as a keyboard, a keypad, a mouse device, a touch-pad, a touch-screen, and the like, and an output device such as a printer, a speaker, and the like. In some embodiments, the I/O device 1040 may include the display device 1060.

The power supply 1050 may provide power for operations of the electronic device 1000.

The display device 1060 may be connected to other components through buses or other communication links.

Aspects of some embodiments according to the present disclosure may be applied to a display device and an electronic device including the display device. For example, aspects of embodiments according to the present disclosure may be applied to a smart phone, a mobile phone, a smart pad, a smart watch, a tablet computer, a car navigation system, a television, a computer monitor, a laptop, etc.

The foregoing is illustrative of aspects of some embodiments of the present disclosure and is not to be construed as limiting thereof. Although aspects of some embodiments of the present disclosure have been described, those skilled in the art will readily appreciate that many modifications are possible in the embodiments without materially departing from the novel teachings and characteristics of embodiments according to the present disclosure. Accordingly, all such modifications are intended to be included within the scope of embodiments according to the present disclosure as defined in the appended claims, and their equivalents. In the claims, means-plus-function clauses are intended to cover the structures described herein as performing the recited function and not only structural equivalents but also equivalent structures. Therefore, it is to be understood that the foregoing is illustrative of aspects of some embodiments of the present disclosure and is not to be construed as limited to the specific embodiments disclosed, and that modifications to the disclosed embodiments, as well as other embodiments, are intended to be included within the scope of the appended claims, and their equivalents. Embodiments according to the present disclosure are defined by the following claims, with equivalents of the claims to be included therein.

What is claimed is:

1. An emission driving circuit comprising:
a pull-up controller configured to transmit a first voltage to a first pull-up control node in response to an input signal, to control a voltage of a second pull-up control node in response to a voltage of the first pull-up control node and a clock signal, and to transmit a second voltage to a third pull-up control node in response to the voltage of the second pull-up control node;
a pull-down controller configured to transmit the input signal to a second pull-down control node in response to the input signal and the clock signal; and
an output circuit configured to output an emission signal from an output node in response to a voltage of the third pull-up control node and a voltage of the second pull-down control node.

2. The emission driving circuit of claim 1, wherein the pull-up controller includes:
a first transistor including a first gate electrode configured to receive the input signal, a first electrode configured to receive the first voltage, and a second electrode connected to the first pull-up control node;
a second transistor including a first gate electrode connected to the first pull-up control node, a first electrode connected to the second pull-up control node, and a second electrode configured to receive the clock signal;
a third transistor including a first gate electrode connected to the second pull-up control node, a first electrode connected to the third pull-up control node, and a second electrode configured to receive the second voltage; and
a first capacitor including a first electrode connected to the first pull-up control node, and a second electrode configured to receive the clock signal.

3. The emission driving circuit of claim 2, wherein the pull-up controller further includes a fourth transistor including a first gate electrode connected to a first pull-down control node, a first electrode configured to receive the first voltage, and a second electrode connected to the second pull-up control node, and
wherein the fourth transistor is configured to transmit the first voltage to the second pull-up control node in response to a voltage of the first pull-down control node.

4. The emission driving circuit of claim 3, wherein the pull-up controller further includes:
a fifth transistor including a first gate electrode connected to the first pull-down control node, a first electrode configured to receive the first voltage, and a second electrode connected to the third pull-up control node; and
a second capacitor including a first electrode configured to receive the first voltage, and a second electrode connected to the third pull-up control node.

5. The emission driving circuit of claim 1, wherein the pull-down controller further includes:
a sixth transistor including a first gate electrode configured to receive the clock signal, a first electrode configured to receive the input signal, and a second electrode connected to a first pull-down control node; and
a seventh transistor including a first gate electrode configured to receive the second voltage, a first electrode connected to the first pull-down control node, and a second electrode connected to the second pull-down control node.

6. The emission driving circuit of claim 1, wherein the output circuit includes:
an eighth transistor including a first gate electrode connected to the third pull-up control node, a first electrode configured to receive the first voltage, and a second electrode connected to the output node;
a ninth transistor including a first gate electrode connected to the second pull-down control node, a first electrode connected to the output node, and a second electrode configured to receive the second voltage; and
a third capacitor including a first electrode connected to the second pull-down control node, and a second electrode connected to the output node.

7. The emission driving circuit of claim 1, at least one transistor of a plurality of transistors included in the emission driving circuit includes a first gate electrode and a second gate electrode.

8. The emission driving circuit of claim 7, wherein the second gate electrode of the at least one transistor is connected to the first gate electrode of the at least one transistor.

9. A display device comprising:
a display panel;
a scan driver configured to output a scan signal to a scan line of the display panel;
a data driver configured to output a data voltage to a data line of the display panel; and
an emission driver including an emission driving circuit configured to output an emission signal to an emission line of the display panel,
wherein the emission driving circuit includes:
a pull-up controller configured to transmit a first voltage to a first pull-up control node in response to an input signal, to control a voltage of a second pull-up control node in response to a voltage of the first pull-up control node and a clock signal, and to transmit a second voltage to a third pull-up control node in response to the voltage of the second pull-up control node;
a pull-down controller configured to transmit the input signal to a second pull-down control node in response to the input signal and the clock signal; and
an output circuit configured to output the emission signal from an output node in response to a voltage of the third pull-up control node and a voltage of the second pull-down control node.

10. The display device of claim 9, wherein the pull-up controller includes:
a first transistor including a first gate electrode configured to receive the input signal, a first electrode configured to receive the first voltage, and a second electrode connected to the first pull-up control node;
a second transistor including a first gate electrode connected to the first pull-up control node, a first electrode connected to the second pull-up control node, and a second electrode configured to receive the clock signal;
a third transistor including a first gate electrode connected to the second pull-up control node, a first electrode connected to the third pull-up control node, and a second electrode configured to receive the second voltage; and
a first capacitor including a first electrode connected to the first pull-up control node, and a second electrode configured to receive the clock signal.

11. The display device of claim 10, wherein the pull-up controller further includes a fourth transistor including a first gate electrode connected to a first pull-down control node, a first electrode configured to receive the first voltage, and a second electrode connected to the second pull-up control node, and
wherein the fourth transistor is configured to transmit the first voltage to the second pull-up control node in response to a voltage of the first pull-down control node.

12. The display device of claim 11, wherein the pull-up controller further includes:
a fifth transistor including a first gate electrode connected to the first pull-down control node, a first electrode configured to receive the first voltage, and a second electrode connected to the third pull-up control node; and
a second capacitor including a first electrode configured to receive the first voltage, and a second electrode connected to the third pull-up control node.

13. The display device of claim 9, wherein the pull-down controller further includes:
a sixth transistor including a first gate electrode configured to receive the clock signal, a first electrode configured to receive the input signal, and a second electrode connected to a first pull-down control node; and
a seventh transistor including a first gate electrode configured to receive the second voltage, a first electrode connected to the first pull-down control node, and a second electrode connected to the second pull-down control node.

14. The display device of claim 9, wherein the output circuit includes:
an eighth transistor including a first gate electrode connected to the third pull-up control node, a first electrode configured to receive the first voltage, and a second electrode connected to the output node;
a ninth transistor including a first gate electrode connected to the second pull-down control node, a first electrode connected to the output node, and a second electrode configured to receive the second voltage; and
a third capacitor including a first electrode connected to the second pull-down control node, and a second electrode connected to the output node.

15. An electronic device comprising:
a processor configured to output a control signal and input image data;
a display panel;
a scan driver configured to output a scan signal to a scan line of the display panel;
a data driver configured to output a data voltage to a data line of the display panel;
an emission driver including an emission driving circuit configured to output an emission signal to an emission line of the display panel; and
a controller configured to control the scan driver, the data driver, and the emission driver based on the control signal and the input image data,
wherein the emission driving circuit includes:
a pull-up controller configured to transmit a first voltage to a first pull-up control node in response to an input signal, to control a voltage of a second pull-up control node in response to a voltage of the first pull-up control node and a clock signal, and to transmit a second voltage to a third pull-up control node in response to the voltage of the second pull-up control node;
a pull-down controller configured to transmit the input signal to a second pull-down control node in response to the input signal and the clock signal; and
an output circuit configured to output the emission signal from an output node in response to a voltage of the third pull-up control node and a voltage of the second pull-down control node.

16. The electronic device of claim 15, wherein the pull-up controller includes:
a first transistor including a first gate electrode configured to receive the input signal, a first electrode configured to receive the first voltage, and a second electrode connected to the first pull-up control node;
a second transistor including a first gate electrode connected to the first pull-up control node, a first electrode connected to the second pull-up control node, and a second electrode configured to receive the clock signal;
a third transistor including a first gate electrode connected to the second pull-up control node, a first electrode connected to the third pull-up control node, and a second electrode configured to receive the second voltage; and
a first capacitor including a first electrode connected to the first pull-up control node, and a second electrode configured to receive the clock signal.

17. The electronic device of claim 16, wherein the pull-up controller further includes a fourth transistor including a first gate electrode connected to a first pull-down control node, a first electrode configured to receive the first voltage, and a second electrode connected to the second pull-up control node, and
wherein the fourth transistor is configured to transmit the first voltage to the second pull-up control node in response to a voltage of the first pull-down control node.

18. The electronic device of claim 17, wherein the pull-up controller further includes:
a fifth transistor including a first gate electrode connected to the first pull-down control node, a first electrode configured to receive the first voltage, and a second electrode connected to the third pull-up control node; and
a second capacitor including a first electrode configured to receive the first voltage, and a second electrode connected to the third pull-up control node.

19. The electronic device of claim 15, wherein the pull-down controller further includes:
a sixth transistor including a first gate electrode configured to receive the clock signal, a first electrode configured to receive the input signal, and a second electrode connected to a first pull-down control node; and
a seventh transistor including a first gate electrode configured to receive the second voltage, a first electrode connected to the first pull-down control node, and a second electrode connected to the second pull-down control node.

20. The electronic device of claim 15, wherein the output circuit includes:
an eighth transistor including a first gate electrode connected to the third pull-up control node, a first electrode configured to receive the first voltage, and a second electrode connected to the output node;
a ninth transistor including a first gate electrode connected to the second pull-down control node, a first electrode connected to the output node, and a second electrode configured to receive the second voltage; and
a third capacitor including a first electrode connected to the second pull-down control node, and a second electrode connected to the output node.
